(19) United States
(12) Patent Application Publication
(10) Pub. No.: US 2024/0257062 A1
(43) Pub. Date: Aug. 1, 2024

(54) COMPUTING SYSTEM THAT FACILITATES TIME MANAGEMENT VIA GRAPH INTELLIGENCE

(71) Applicant: Microsoft Technology Licensing, LLC, Redmond, WA (US)

(72) Inventors: Vipindeep VANGALA, Hyderabad (IN); Jatin KAKKAR, Hyderabad (IN); Pankaj Vasant KHANZODE, Hyderabad (IN)

(21) Appl. No.: 18/565,439

(22) PCT Filed: May 5, 2022
(86) PCT No.: PCT/US22/27743

§ 371 Date: Nov. 29, 2023

(30) Foreign Application Priority Data
May 31, 2021 (IN) 202141024177

(51) Int. Cl. G06Q 10/109; G06Q 10/0639

(52) U.S. Cl. CPC G06Q 10/109; G06Q 10/06393

(57) ABSTRACT

A computing system identifies a user graph for a user, where the user graph comprises nodes and edges connecting the nodes. The nodes comprise topic nodes and entity nodes representing documents of the user. The computing system identifies a cluster of the topic nodes corresponding to a productivity area of the user. The computing system performs a walk of the user graph based upon the cluster to identify activities performed by the user with respect to the productivity area within a period of time. The computing system computes a score for the productivity area based upon types of each of the activities and a number of times each of the activities were performed and causes graphical data to be presented on a display based upon the score. The graphical data may include the score and a suggestion to the user as to how to improve productivity.

### BACKGROUND

Computer-executable applications that help users to manage their time are important in maximizing productivity. However, conventional time tracking applications have limited functionality. With more specificity, conventional time tracking applications track time spent by a user within an individual application (e.g., time spent in an email application drafting emails, time spent in meetings in a meeting application, etc.) or an overall time the user spends utilizing a computing device (e.g., time spent logged in to the computing device). Thus, conventional time tracking applications have limited usefulness, especially in enterprise settings.

### SUMMARY

The following is a brief summary of subject matter that is described in greater detail herein. This summary is not intended to be limiting as to the scope of the claims.

Described herein are various technologies that facilitate time management via graph intelligence. For example, a computing system is described herein that identifies activities performed by a user with respect to a productivity area (e.g., a particular project the user is working on) within a period of time, where the productivity area is identified by clustering nodes within a user graph for the user. The computing system computes a score based upon numbers and types of the activities, where the score is indicative of effort exerted by the user in the productivity area within the period of time. The computing system computes scores for different productivity areas of the user in a similar fashion and assigns rankings to the productivity areas based upon the scores. The computing system may generate suggestions for optimizing productivity time of the user based upon the scores. The computing system causes graphical data pertaining to at least a subset of the productivity areas to be presented on a display based upon the rankings. The graphical data may include identifiers for the productivity areas, the suggestions, and/or identifiers for people and/or documents that are relevant to the productivity areas within the period of time. The scores help the user obtain a perspective of their activities in digital ecosystems within the period of time and may be used for analytics and improvement purposes.

As another example of computing the score, a computing system obtains a user graph for a user based upon an identifier for the user. The user graph includes nodes and edges connecting the nodes. The nodes include topic nodes representing topics of the user and entity nodes, where entity nodes represent people associated with the user, documents (e.g., text documents, emails, real-time messages, etc.) associated with the user, and/or derived information that is derived from the documents. The computing system identifies clusters of topic nodes within the user graph, where each cluster is indicative of a different productivity area of the user. The computing system then performs a walk of the user graph based upon topic nodes in each of the clusters to identify activities performed by the user with respect to each productivity area within a period of time (e.g., a period of time extending from a current time to a prior time). In an example, an entity node assigned to a document may include metadata which identifies a type of the document and a manner in which the document was accessed by the user (e.g., whether the user created the document, viewed the document, edited the document, etc.). The computing system identifies the activities performed by the user based upon the metadata.

To continue the example, the computing system computes a score for the productivity area based upon respective types of each of the activities and a number of times each of the activities were performed within the time period, where the score for the productivity area is indicative of an amount of effort exerted by the user in the productivity area within the period of time. In an example, the computing system assigns a weight to each activity identified for the productivity area based upon a type of the activity. In an example where the activities include drafting a first email, attending a meeting, and drafting a second email, the computing system assigns a first weight to drafting the first email, a second weight to attending the meeting, and (a second instance of) the first weight to drafting the second email. The computing system then computes a score for the productivity area based upon each weight for each activity identified for the productivity area.

Stated differently, the computing system may compute the score for the productivity area by computing a first sub-score for a first type of activity (e.g., email drafting) in the productivity area and a second sub-score for a second type of activity (e.g., attending meetings) in the productivity area. The computing system computes a score for each productivity area and may normalize the scores such that each score is expressed as a percentage. The computing system ranks each productivity area based upon the scores and causes graphical data pertaining to at least a subset of the productivity areas to be presented on the display. The graphical data presented on the display may include identifiers for the productivity areas and their respective scores, where the user may examine the scores in order to ascertain efforts exerted in each of the productivity areas within the period of time. The graphical data may also include identifiers for documents, people, and/or derived information that are relevant for each productivity area. According to embodiments, the graphical data is presented within a graphical user interface (GUI) for a productivity application, such as an email application, where different regions of the GUI correspond to different productivity areas. According to embodiments, the computing system identifies that certain activities can be delegated to other users based upon the scores and causes suggestions for delegating the activities to be presented within the graphical data. According to embodiments, the computing determines that the user should spent more or less effort (e.g., time) working in a productivity area based upon the scores and causes a suggestion to be presented within the graphical data, where the suggestion notifies the user that he/she should be spending more or less effort working in the productivity area in comparison to an amount of effort exerted by the user with respect to the productivity area within the period of time. According to embodiments, the computing system determines that the user should spend more or less effort with respect to a particular activity (e.g., email drafting) in a productivity area based upon a sub-score for the particular activity. According to embodiments, the computing system computes scores for each member of a team that works in a productivity area and computes an overall score for the productivity area based upon the scores for each member, where the overall score is indicative of an amount of effort exerted by the team with respect to the productivity area within the period of time.

The above-described technologies present various advantages over conventional time tracking applications. First, unlike conventional time tracking applications which track time on a per-application basis, the above-described technologies track time on a productivity area basis, where the productivity areas are identified via clustering of nodes in a user graph. Second, vis-à-vis computing a score for a productivity area based upon different weights assigned to different types of activities performed by the user with respect to the productivity area, the above-described technologies are able to better capture mental “effort” expended by the user in the productivity area, which conventional time tracking applications are unable to do. Third, by aggregating scores for different users in a productivity area to create an overall score for the productivity area, the above-described technologies enable a team to operate more efficiently.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an example computing environment that facilitates time management via graph intelligence.

FIGS. 2A-2B are illustrations of an example user graph.

FIG. 3 illustrates an example graphical user interface (GUI) that facilitates time management via graph intelligence.

FIG. 4 illustrates an example graphical user interface (GUI) that facilitates time management of a team via graph intelligence.

FIG. 5 is a flow diagram that illustrates an example methodology performed by a computing system that facilitates time management of a user via graph intelligence.

FIG. 6 is a flow diagram that illustrates another example methodology performed by a computing system that facilitates time management of a team via graph intelligence.

FIG. 7 is an example computing device.

Various technologies pertaining to facilitating time management via graph intelligence are now described with reference to the drawings, where like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

### DETAILED DESCRIPTION

As noted above, conventional time tracking applications track time on a per-application basis and hence have limited usefulness, such as in enterprise settings where tracking personal productivity and identifying potential improvements is important. In an example, a conventional time tracking application tracks time of a user spent in an email application and reports the tracked time to the user. However, different applications may be utilized by the user to accomplish a single goal. In an example, when a user is working on a project (e.g., a productivity area), the user uses an email application to send and receive emails with respect to the project, a real-time messaging application to send and receive real-time messages with respect to the project, a word processing application to generate text documents with respect to the project, and so forth. While a conventional time tracking application may track time spent by the user in each of these applications, the tracked time is not associated with a productivity area. In an example, an email application is utilized by a user to draft a first set of emails pertaining to a first productivity area and a second set of emails pertaining to a second productivity area. A conventional time tracking application may report an amount of time spent by the user in the email application, but does not distinguish between time spent drafting the first emails pertaining to the first productivity area and time spent drafting the second emails pertaining to the second productivity area.

A computing system is described herein that is configured to track efforts of a user in different productivity areas within a period of time. The computing system identifies the productivity areas by identifying clusters of nodes in a user graph for a user. The computing system then identifies activities performed by the user with respect to the productivity areas within the period of time by performing a walk of the user graph based upon topic nodes in each cluster. The computing system computes a score for each productivity area based upon respective types of each of the activities and a number of times each of the activities were performed during the time period, where a score for a productivity area is indicative of an amount of effort exerted by the user in the productivity area within the period of time. The computing system ranks the productivity areas based upon the scores and causes graphical data pertaining to at least a subset of the productivity areas to be presented on a display based upon the rankings. Graphical data for a particular productivity area may include an identifier for the productivity area, the score for the productivity area, a suggestion as to how the user can optimize his/her time with respect to the productivity area, and identifiers for people, documents, and/or derived information of the productivity area.

Briefly, a computing system obtains a user graph for a user based upon an identifier for the user. The user graph includes nodes and edges connecting the nodes. The nodes include topic nodes representing topics of the user and entity nodes, where entity nodes represent people associated with the user (e.g., people with whom the user has communicated electronically), documents (e.g., text documents, emails, real-time messages, etc.) associated with (e.g., created by, edited by, viewed by, etc.) the user, and/or derived information that is derived from the documents. The computing system identifies clusters of topic nodes within the user graph, where each cluster is indicative of a different productivity area of the user. The computing system performs a walk of the user graph based upon topic nodes in each of the cluster to identify activities performed by the user with respect to each productivity area within a period of time. The period of time may extend from a current time to a prior time (e.g., the past day, the past week, the past three months). Furthermore, the period of time may be modified according to needs of the user or needs of an organization to which the user belongs. In an example, an entity node assigned to a document may include metadata which identifies a type of the document and a manner in which the document was accessed by the user (e.g., whether the user created the document, viewed the document, edited the document, etc.). The computing system identifies the activities based upon the metadata. The computing system may disregard activities performed with respect to the productivity area that have not occurred within the period of time.

The computing system computes a score for the productivity area based upon respective types of each of the activities and a number of times each of the activities were performed within the time period. In an example, the computing system assigns a weight to each activity identified for the productivity area based upon a type of the activity. In an example where the activities performed by the user with respect to the productivity area within the time period include attending a first meeting, drafting a first text document, viewing a second text document, and attending a second meeting, the computing system assigns a first weight to attending the first meeting, a second weight to drafting the first text document, a third weight to viewing the second text document, and (a second instance of) the first weight to attending the second meeting. The computing system then computes a score for the productivity area based upon each weight, where the score for the productivity area is indicative of an amount of effort exerted by the user in the productivity area within the period of time. Stated differently, the computing system may compute the score for the productivity area by computing a first sub-score for a first type of activity (e.g., attending meetings), a second sub-score for a second type of activity (e.g., drafting text documents), and a third sub-score for a third type of activity (e.g., viewing text documents). The score may not explicitly be based upon time spent by the user performing the activities in the productivity area, but rather on the types and number of times each of the activities were performed. The computing system computes scores for each productivity area and may normalize the scores such that each score is expressed as a percentage. The computing system ranks the productivity areas based upon the scores and causes graphical data pertaining to at least a subset of the productivity areas to be presented on a display based upon the rankings. In an example, the graphical data includes identifiers for the productivity areas and their respective scores, where the user may examine the scores to ascertain how his/her efforts have been distributed among the productivity areas over the period of time. In another example, the graphical data includes identifiers for people, documents, and/or derived information that are pertinent to each of the productivity areas. According to embodiments, the computing system generates suggestions (based upon the scores) that certain activities be delegated to other users in order to increase productivity of the user and causes the suggestions to be included in the graphical data. According to embodiments, the computing determines that the user should spend more or less effort (e.g., time) working in a productivity area based upon the scores and causes a suggestion to be presented within the graphical data, where the suggestion notifies the user that he/she should be spending more or less effort working in the productivity area in comparison to an amount of effort exerted by the user in the productivity area within the period of time. According to embodiments, the computing system determines that the user should spend more or less effort with respect to a particular activity (e.g., attending meetings) in a productivity area based upon a sub-score for the particular activity. According to embodiments, the computing system computes scores for each member of a team that works in a productivity area and computes an overall score for the productivity area based upon the scores for each member, where the overall score is indicative of an amount of effort exerted by the team with respect to the productivity area within the period of time (which may be modified based upon needs of the user or needs of the team) As described above, the computing system identifies productivity areas and scores for each productivity area, where each score is indicative of efforts of the user exerted in a productivity area. According to some embodiments, the computing system ranks the productivity areas based upon the scores, and identifiers for the productivity areas and their corresponding scores are presented to the user as a daily or weekly digest via email. This enables the user to understand, optimize, and manage their own daily work. In an example, the user identifies that they are spending a relatively large amount of their efforts on a “patent review” project and spending a relatively large amount of their efforts attending meetings. The user can then optimize his/her time by reducing his/her meeting attendance.

Information pertaining to the productivity areas (e.g. identifiers for productivity areas, scores for productivity areas, and so forth) described above can be presented as a dashboard in a communication application (such as an email application or a real-time messaging application) providing an on-demand view for the user along with artificial intelligence (AI) generated rankings and recommendations. In an example, the computing system identifies a productivity area which is important based on the people involved (like management personnel or a key project area, inferred from the user graph via graph intelligence)—and suggests that the user focus on the productivity area.

According to embodiments, the above-described technologies may be extended to a tenancy graph of a tenancy (e.g., an organization) to which the user belongs in order to utilize organizational dynamics of the organization in generating suggestions for the user with respect to the productivity areas of the user.

The above-described technologies present various advantages over conventional time tracking applications. First, unlike conventional time tracking applications which track time on a per-application basis, the above-described technologies track time on a productivity area basis, where the productivity areas are identified via clustering of nodes in a user graph. Second, vis-à-vis computing a score for a productivity area based upon different weights assigned to different types of activities performed by the user with respect to the productivity area, the above-described technologies are able to better capture mental “effort” expended by the user on the productivity area, which conventional time tracking applications are unable to do. Third, by aggregating scores for different users in a productivity area to create an overall score for the productivity area, the above-described technologies enable a team to operate more efficiently. Fourth, via the ranking of the productivity areas based upon their respective scores and presenting graphical data pertaining to a subset of the productivity areas on a display based upon the rankings, the technologies described herein efficiently utilize limited screen of the display and ensure that the user is not overwhelmed with information.

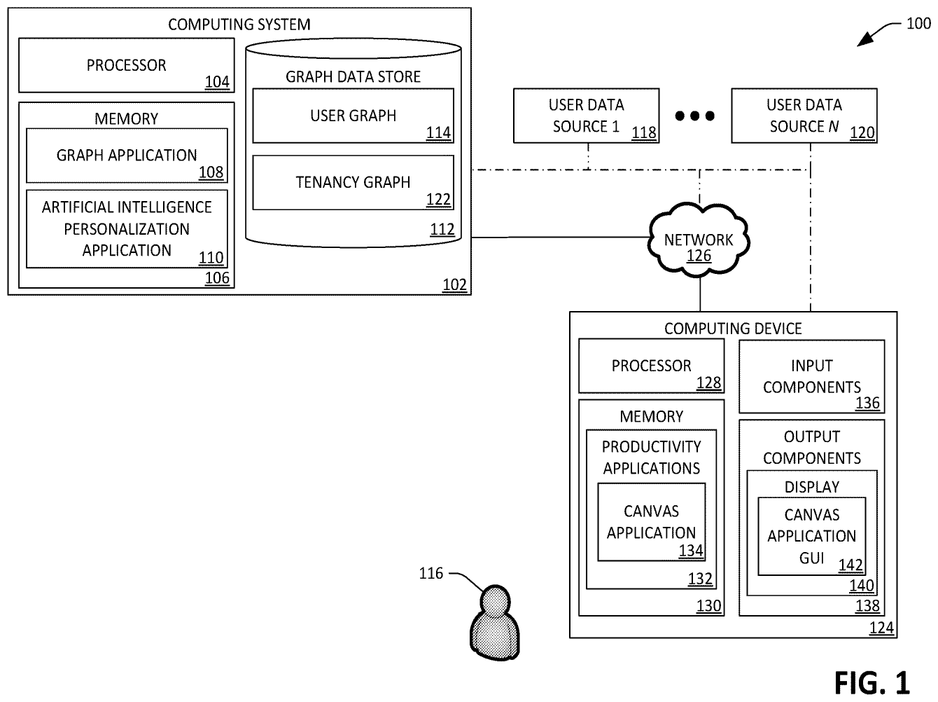

With reference to FIG. 1, an example computing environment 100 that facilitates time management via graph intelligence is illustrated. The computing environment 100 includes a computing system 102. In some embodiments, the computing system 102 may be or include a cloud computing service. The computing system 102 includes a processor 104 and memory 106. The memory 106 has a graph application 108 and an artificial intelligence (AI) personalization application 110 loaded therein. As will be described in greater detail below, the graph application 108, when executed by the processor 104, is configured to obtain (e.g., receive or generate) user activity data from a plurality of applications and to generate and maintain user graphs for the users based upon the user activity data. The user activity data may include historical activity data and/or real-time data collected via a plugin or interop communication. In some embodiments, the graph application 108 is also configured to generate tenancy graphs. The AI personalization application 110, when executed by the processor 104, is configured to facilitate time management via graph intelligence (described in greater detail below).

The computing system 102 further includes a graph data store 112. The graph data store 112 stores a user graph 114 for a user 116. Although not depicted in FIG. 1, it is to be understood that the graph data store 112 stores a plurality of user graphs for a plurality of users, where each of the user graphs in the graph data store 112 may be indexed by an identifier for a corresponding user. The user graph 114 includes nodes and edges connecting the nodes. The nodes include topic nodes and entity nodes. The topic nodes represent topics that are relevant to the user 116. The entity nodes represent people (e.g., other users) associated with the user 116 (e.g., people nodes), documents of the user 116 (e.g., document nodes), or derived information of the user 116 that is derived from the documents (e.g., derived nodes). The entity nodes may also represent tenancies (e.g., a group, a team, or an organization) of the user 116. Thus, the user graph 114 for the user 116 is a heterogenous graph. The graph application 108 generates the topic nodes by applying a variety of AI models and algorithms (e.g., classification models and algorithms) to documents represented by the entity nodes. Each edge in the user graph 114 is assigned criteria that is indicative of a relationship between entities represented by nodes that are connected by a respective edge.

The people associated with the user 116 are people with whom the user 116 has communicated with electronically or that are working in one or more productivity areas of the user 116 (to be explained below). The people associated with the user 116 may be contacts of the user 116. In an example, the user 116 communicates with the people associated with the user 116 via an email application (e.g., Microsoft® Outlook®) or a real-time messaging application (e.g., Microsoft Teams®). The real-time messaging application enables the user 116 to communicate over a network connection with other people in real-time using text-based communication, audio-based communication, video-based communication, or a combination thereof. In an example, the people associated with the user 116 work together in a productivity area.

The documents of the user 116 are computer-readable content that is associated with (e.g., created by, edited by, accessed by, able to be accessed by, and/or viewed by) the user 116. Documents of the user 116 may include text documents, spreadsheets, slideshows, emails, and real-time messages. According to embodiments, the text documents are Microsoft® Word documents, the spreadsheets are Microsoft® Excel spreadsheets, the slideshows are Microsoft® PowerPoint® slideshows, the emails are authored, received, and viewed in Microsoft® Outlook®, and the real-time messages are authored, received, and viewed in Microsoft Teams®. According to embodiments, the documents of the user 116 include transcriptions of real-time audio/visual meetings conducted over a network connection via a meeting application (e.g., Microsoft Teams®). The documents of the user 116 may also include information associated with a calendar/scheduling application (e.g., Microsoft® Outlook®). In an example, the information associated with the calendar/scheduling application includes meetings that the user 116 has or will attend (e.g., calendar entries), commitments of the user 116 (e.g., tasks to be completed by the user 116 that are tracked by the calendar/scheduling application), and so forth. The documents of the user 116 may also include contact information (e.g., names, email addresses, etc.) for contacts of the user 116.

The derived information of the user 116 is derived from the documents. In an example, the derived information of the user 116 includes an acronym and a definition of the acronym found in one of the documents. In another example, the derived information of the user 116 includes a task that the user 116 has agreed to complete in an email or a real-time message with another person.

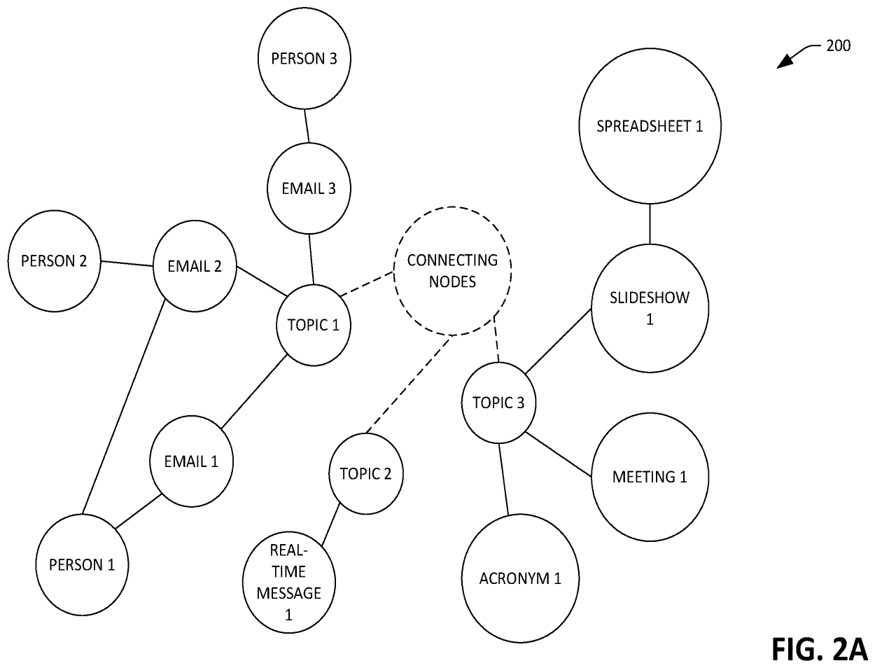

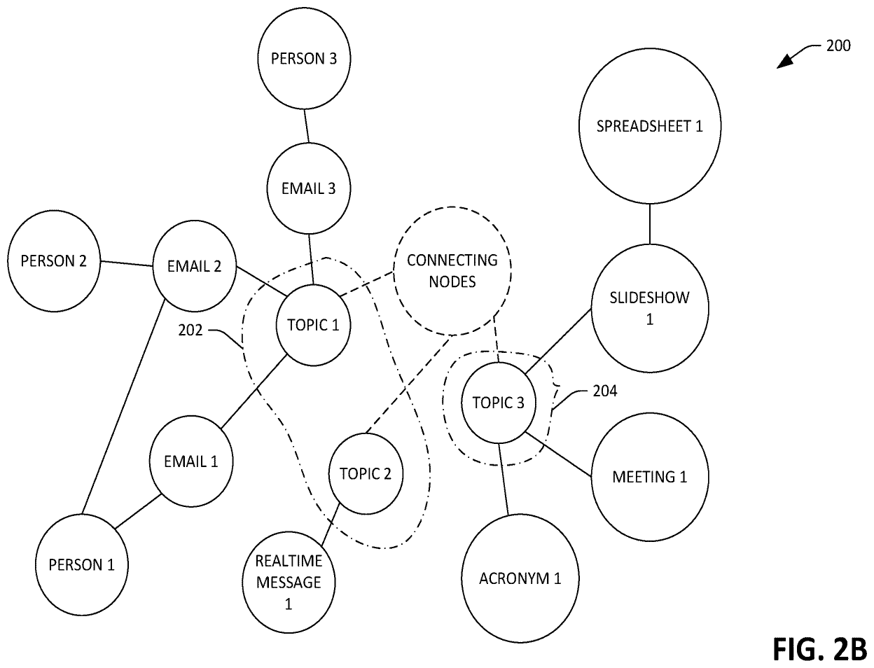

Referring now to FIG. 2A, an example user graph 200 is depicted. The user graph 200 may be or include the user graph 114 or the user graph 114 may be or include the user graph 200. The user graph 200 includes nodes (represented by circles in FIG. 2A) and edges (represented by lines in FIG. 2A) connecting the nodes. Each node is a topic node (e.g., topic node 1, topic node 2, topic node 3) or an entity node. Entity nodes include nodes representing people (e.g., person node 1, person node 2, person node 3), nodes representing documents (e.g., email node 1, email node 2, email node 3, real-time message node 1, slideshow node 1, spreadsheet node 1, meeting node 1), or nodes representing derived information (e.g., acronym node 1). It is contemplated that the user graph 200 may include many nodes (e.g., hundreds, thousands, millions, and so forth). In the example depicted in FIG. 2A, topic node 1, topic node 2, and topic node 3 are connected to one another in the user graph 200 by many connecting nodes and connecting edges (illustrated by dotted circles and dotted lines, respectively).

Referring back to FIG. 1, the computing environment 100 further includes a first user data source 118 and an Nth user data source 120 that store data of the user 116, where N is a positive integer greater than one (collectively referred to herein as “the plurality of user data sources 118-120”).

The plurality of user data sources 118-120 store the documents of the user 116, derived information of the user 116, or other data of the user 116. In an example, the first user data source 118 stores a text document authored by the user 116 and the Nth user data source 120 stores an email sent by the user 116 to a contact of the user 116. According to embodiments, the plurality of user data sources 118-120 are or include cloud-based storage, server-based storage, and/or local storage of devices operated by the user 116.

Nodes in the user graph 114 may include metadata. In an example, metadata for a node in the user graph 114 representing a document authored by the user 116 includes an identifier for the document, an identifier for a storage location of the document (e.g., one of the plurality of user data sources 118-120), a time of creation of the document, a manner in which the document was accessed (e.g., whether the document was created by the user 116, edited by the user 116, and/or viewed by the user 116), etc.

According to embodiments, the graph data store 112 further stores a tenancy graph 122 for a tenancy (e.g., a group, a team, or an organization) of the user 116. The tenancy graph 122 is similar to the user graph 114. For instance, the tenancy graph 122 includes nodes and edges connecting the nodes. The nodes in the tenancy graph 122 include topic nodes and entity nodes. However, unlike the user graph 114, the nodes representing documents in the tenancy graph 122 represent documents that are associated with the tenancy and that are accessible to the user 116, but that may or may not have been previously accessed by the user 116. For this reason, the tenancy graph 122 may include nodes (e.g., representing topics, documents, etc.) and edges that are not represented in the user graph 114 and vice versa. Although not depicted in FIG. 1, it is to be understood that the user 116 may belong to more than one tenancy, and hence, the graph data store 112 may store a tenancy graph for each tenancy to which the user 116 belongs (as well as tenancy graphs for tenancies to which the user 116 does not belong).

The computing environment 100 additionally includes a computing device 124 that is operated by the user 116. In an example, the computing device 124 may be a desktop computing device, a laptop computing device, a tablet computing device, a smartphone, etc. The computing device 124 is in communication with the computing system 102 by way of a network 126 (e.g., the Internet, intranet, etc.). According to embodiments, the computing device 124 is in communication with one or more of the plurality of user data sources 118-120. It is to be understood that some or all of the plurality of user data sources 118-120 may be part of the computing device 124.

The computing device 124 includes a processor 128 and memory 130, where the memory 130 has productivity applications 132 loaded therein. In general, the productivity applications 132, when executed by the processor 128, are configured to enable the user 116 to create computer-readable content and/or communicate with other people (e.g., users) over the network 126. The productivity applications 132 may be or include a document application, a spreadsheet application, a slideshow application, an email application, and/or a real-time messaging application. Likewise, according to embodiments, the productivity applications 132 include Microsoft® Word, Microsoft® Excel, Microsoft® PowerPoint®, Microsoft® Outlook®, and/or Microsoft Teams®. According to some embodiments, the productivity applications 132 include a web browser.

The productivity applications 132 include a canvas application 134. According to embodiments, the canvas application 134 is an email application (e.g., Microsoft® Outlook®) or a real-time messaging application (e.g., Microsoft Teams®). As will be described in greater detail below, the canvas application 134 is generally configured to generate a GUI that facilitates time management. The computing device 124 includes input components 136 that enable the user 116 to set forth input to the computing device 124. The input components 136 may include a mouse, a keyboard, a trackpad, a scroll wheel, a microphone, a camera, a touchscreen, a video camera, etc. The computing device 124 also includes output components 138 that enable data to be presented to the user 116. The output components 138 include a display 140, where graphical features are presented thereon. The display 140 may be a touchscreen display. The canvas application 134 (or another application) presents a GUI 142 (also referred to herein as “the canvas application GUI 142”) on the display 140. The output components 138 may also include a speaker, a haptic feedback device, etc. (not illustrated in FIG. 1).

Example operation of the computing environment 100 is now set forth. If the user 116 opts-in, the graph application 108 obtains (e.g., receives or generates) user activity data of the user 116 from a plurality of applications and generates and maintains the user graph 114 for the user 116 based upon the user activity data. The user activity data may include historical activity data of the user 116 and/or real-time data of the user 116 collected via a plugin or interop communication. In an example, an email application is utilized by the user 116 to draft and send an email to a contact of the user 116. The graph application 108 obtains the email and identifies a topic of the email (e.g., using AI models and algorithms). The graph application 108 generates an entity node representing the email, identifies a topic node in the user graph 114 corresponding to the topic, and connects the entity node to the topic node via an edge, where the edge is assigned criteria indicating that the email belongs to the topic. In the event that a node representing the topic does not currently exist in the user graph 114, the graph application 108 creates the topic node and connects the entity node to the topic node via the edge. It is to be understood that the graph application 108 may identify more than one topic for a document and as such, an entity node representing the document may be connected to more than one topic node. Furthermore, the graph application 108 may connect the entity node to other entity nodes via edges. In an example, the graph application 108 connects the entity node representing the email to a person node representing the contact of the user 116 with an edge and assigns the edge criteria indicating that the email was sent to the contact of the user 116. In some embodiments, the graph application 108 also generates and maintains the tenancy graph 122 for the tenancy of the user 116.

The AI personalization application 110 obtains an identifier for the user 116. In one example, the AI personalization application 110 receives the identifier from the computing device 124. In another example, the AI personalization application 110 has access to identifiers for a plurality of users and accesses the identifier for the user 116 periodically (e.g., once an hour, once a day, etc.). In yet another example, the AI personalization application 110 obtains the identifier for the user 116 when the user graph 114 for the user 116 is updated to reflect new activities performed by the user 116 via computer-executable applications, such as creating a new document.

The AI personalization application 110 retrieves the user graph 114 for the user 116 based upon the identifier for the user 116. In an example, the AI personalization application 110 may execute a search over user graphs stored in the graph data store 112 based upon the identifier for the user 116. The search produces search results, where the search results include the user graph 114. According to embodiments, the AI personalization application 110 may provide the identifier for the user 116 to the graph application 108. According to the embodiments, the graph application 108 executes the search and returns the user graph 114 to the AI personalization application 110. The AI personalization application 110 identifies a subset of topic nodes (also referred to herein as a cluster of topic nodes) in the user graph 114, where the subset of topic nodes corresponds to a productivity area of the user 116. In an example, the productivity area is a project worked on by the user 116 along with other users. The AI personalization application 110 may identify different clusters of topic nodes, where each cluster corresponds to a different productivity area of the user 116. In an example, the AI personalization application 110 identifies a first cluster of topic nodes and a second cluster of topic nodes within the user graph 114, where the first cluster corresponds to a first productivity area of the user 116 and the second cluster corresponds to a second productivity area of the user 116.

Referring briefly to FIG. 2B, clustering of topic nodes within the user graph 200 is illustrated. As depicted in FIG. 2B, the AI personalization application 110 has identified a first cluster of topic nodes 202 (topic node 1 and topic node 2) corresponding to a first productivity area of the user 116 and a second cluster of topic nodes 204 (topic node 3) corresponding to a second productivity area of the user 116.

Turning back to FIG. 1, according to some embodiments, the AI personalization application 110 identifies clusters of topic nodes using a hierarchical agglomerative clustering algorithm. The AI personalization application 110 may utilize a suitable metric and a suitable linkage criteria to identify the clusters of topic nodes.

According to embodiments, the AI personalization application 110 accesses a list of frequently used topics of the user 116 (generated based upon the user activity data). In an example, the list of frequently used topics is generated based upon emails and/or real-times messages sent to and sent by the user 116 over a window of time from a current time (e.g., within the previous three months). The AI personalization application 110 identifies topic nodes within the user graph 114 corresponding to topics in the list of frequently used topics. The AI personalization application 110 identifies the clusters of nodes using a hierarchical agglomerative clustering algorithm. In this manner, the AI personalization application 110 may identify clusters of topic nodes in a computationally efficient manner that is less subject to noise than clustering the entirety of the topic nodes of the user graph 114.

According to embodiments, the AI personalization application 110 identifies that a first topic node and a second topic node belong to a cluster of topic nodes based upon a number of edges that connect the first topic node to the second topic node within the user graph 114.

Subsequent to identifying the cluster of topic nodes, the AI personalization application 110 takes each topic node within the cluster of topic nodes as a seed node and performs a walk of the user graph 114 based thereon in order to identify people, documents, and/or derived information that are pertinent to the productivity area (referred to herein as “personalized data”). In an example, the AI personalization application 110 locates a topic node (in the cluster of topic nodes) within the user graph 114. The AI personalization application 110 then traverses edges that connect the topic to reach at least one second level node in the user graph 114 (“a first level of expansion”).

For each second level node, the AI personalization application 110 may traverse edges connecting the second level node(s) to at least one third level node (“a second level of expansion”). This process may continue until the AI personalization application 110 reaches a threshold level of expansion (e.g., three levels of expansion). The AI personalization application 110 performs walks of each cluster of topic nodes identified above in a similar manner. In an example where the AI personalization application 110 identifies a first cluster of topic nodes corresponding to a first productivity area and a second cluster of topic nodes corresponding to a second productivity area, the AI personalization application 110 performs a first walk of the user graph 114 based upon the first cluster of topic nodes to identify first personalized data for the user 116 and a second walk of the user graph 114 based upon the second cluster of topic nodes to identify second personalized data for the user 116, where the first personalized data corresponds to the first productivity area and the second personalized data corresponds to the second productivity area.

According to some embodiments, the AI personalization application 110 identifies the productivity area and the activities performed by the user 116 with respect to the productivity areas within the period of time via a plurality of graph clustering techniques.

As noted above, nodes within the user graph 114 may include metadata. As the AI personalization application 110 performs the walk of the user graph 114, the AI personalization application 110 utilizes the metadata for each node that is traversed while performing the walk in order to access information pertaining to people, documents, or derived information represented by each node. In an example, the AI personalization application 110 uses metadata found in a document node for a document to access the document (e.g., from one of the plurality of user data sources 118-120).

The metadata for an entity node may include a time of creation and/or a time of last access of the document represented by the entity node. As such, the AI personalization application 110 may disregard nodes traversed during the walk that have times of creation and/or times of last access that are not within a period of time (e.g., the past week, the past month, the past three months, etc.). The period of time may extend from a current time to a prior time. In an example, the AI personalization application 110 accesses metadata for an entity node traversed during the walk, where the entity node represents a document. Based upon the time of creation and/or time of last access in the metadata, the AI personalization application 110 determines whether the document was created and/or accessed within the period of time. When the document was created and/or accessed within the period of time, the AI personalization application 110 may access the document based upon the metadata and/or mark the document for further analysis. When the document was not created and/or accessed within the period of time, the AI personalization application 110 may disregard the document.

According to embodiments, the topic nodes of the user graph 114 include metadata that indicates a time at which the topic node was last connected to an entity node via an edge. According to the embodiments, the AI personalization application 110 performs the walk of the user graph 114 based upon topic nodes having metadata indicating that the topic node was connected to an entity node via an edge with a period of time extending from a current time to a prior time (e.g., one week, one month, three months, etc.). According to embodiments, the topic nodes of the user graph 114 include metadata that indicates a time at which a document was last accessed, where an entity node representing the document is connected to the topic node via an edge. According to the embodiments, the AI personalization application 110 performs the walk of the user graph 114 based upon topic nodes having metadata indicating that the entity node connected to the topic node was last accessed within the period of time.

Additionally or alternatively, the AI personalization application 110 may identify a subset of people nodes in the user graph 114 using processes similar to those described above with respect to the topic nodes. Additionally or alternatively, the AI personalization application 110 may utilize the subset of people nodes of the user graph 114 as seed nodes for the walk of the user graph 114. As noted above, the AI personalization application 110 performs the walk to identify documents (and people/derived information) that are relevant to a productivity area of the user 116. The AI personalization application 110 identifies activities performed by the user 116 with respect to the productivity area based upon types of the documents and/or manners of access of the documents.

Example activities include drafting emails, reading emails, participating in real-time electronic message exchanges, attending meetings, authoring documents, and reading documents.

The AI personalization application 110 determines a type of each of the documents based upon the metadata for nodes in the user graph 114 corresponding to the documents or based upon the documents themselves. As noted above, documents may include text documents, spreadsheets, slideshows, emails, real-time messages, etc. The documents may also include calendar entries that indicate that the user 116 attended a meeting, that the user 116 agreed to perform a task, and so forth. The AI personalization application 110 also determines a manner of access of each of the documents by the user 116 based upon the metadata for nodes in the user graph 114 corresponding to the documents or based upon the documents themselves. For instance, the AI personalization application 110 determines whether the user 116 created each of the documents, viewed each of the documents 116, attended meetings represented by the documents, and so forth.

In an example where a document identified by the AI personalization application 110 is an email and a manner of access of the document is that the user 116 authored the email, the AI personalization application 110 determines that the activity is drafting an email. In another example where the document is a spreadsheet and the manner of access of the document was that the user 116 viewed the spreadsheet, the AI personalization application 110 determines that the activity is viewing the spreadsheet. In yet another example where the document is a calendar entry for a meeting and the manner of access was that the user 116 attended the meeting, the AI personalization application 110 determines that the activity is attending the meeting.

The AI personalization application 110 computes a score for the productivity area (represented by the cluster) based upon respective types of each of the activities and a number of times each of the activities were performed within the period of time, where the score is indicative of an amount of effort exerted by the user 116 in the productivity area. In an example, the AI personalization application 110 assigns weights to the activities, where a weight for an activity is based upon a type of the activity, and computes the score based upon the weights. In an example where the activities include a first activity of a first type, a second activity of a second type, and a third activity of the first type, the AI personalization application 110 assigns a first weight to the first activity, a second weight to the second activity, and the first weight to the third activity, such that the weights include two instances of the first weight and one instance of the second weight. In a more specific example, the AI personalization application 110 assigns a first weight to drafting a first email, a second weight to attending a meeting, (a second instance of) the first weight to drafting a second email, and a third weight to reading a third email. Generally speaking, the AI personalization application 110 assigns relatively higher weights to activities that require relatively higher amounts of user effort and relatively lower weights to activities that require relatively lower amounts of user effort. In an example, the AI personalization application 110 assigns a first weight to attending a meeting and a second weight to reading an email, where the first weight is greater than the second weight to indicate that attending the meeting requires more user effort than reading the email. The AI personalization application 110 also computes scores for each other productivity area (represented by other clusters identified by the AI personalization application 110) in a similar manner. The AI personalization application 110 may normalize each of the scores for the productivity areas, such that the scores sum to one hundred. As such, after normalization, each score is indicative of a percentage of efforts exerted by the user 116 in a different productivity area of the user 116.

According to embodiments, metadata for entity nodes representing documents in the user graph 114 includes a length of time that the user 116 accessed the documents. In one example, a first entity node representing an email indicates that the user 116 spent a first amount of time drafting the email. In another example, an entity node representing a meeting that the user 116 attended indicates that the user 116 attended the meeting for a second amount of time. According to the embodiments, the AI personalization application 110 modifies weights for the activities based upon lengths of time the user 116 accessed the documents. In an example, the activities include drafting a first email that takes a first length of time and drafting a second email that takes a second length of time that differs from the first length of time. As such, the AI personalization application 110 (initially) assigns a first instance of a weight to the drafting the first email and a second instance of the (same) weight to the second email. The AI application modifies the first instance of the weight by a first factor, where the first factor is based upon the first length of time. The AI personalization application 110 also modifies the second instance of the weight by a second factor, where the second factor is based upon the second length of time. According to the embodiments, the AI personalization application computes the score based upon the modified weights.

According to embodiments, weights for each type of activity are based upon heuristics for a specific organization or global models. The weights may also be learned by a machine learning model that is trained based upon user data provided by users or by a form of privacy preserving telemetry or instrumentation.

According to embodiments, the AI personalization application 110 computes the scores for the productivity areas based upon a machine learning model, where the machine learning model outputs the scores based upon the activities performed by the user 116.

Subsequent to performing the walk of the user graph 114 to identify the personalized data that is pertinent to the productivity area, the AI personalization application 110 may rank the people, the documents, and/or the derived information in the personalized data for the productivity area. The AI personalization application 110 may rank the people, the documents, and/or the derived information based upon suitable factors, such as a number of times a person was contacted by the user 116, a number of times the user 116 contacted the person, positions of the user 116 and the person within an organizational structure, a number of times a document/derived information was accessed, a number of references in the document/derived information to other documents/derived information, a number of references to the document/derived information in other documents/derived information, manually set forth relevance scores, and so forth. The AI personalization application 110 ranks the people, the documents, and/or the derived information in the personalized data for each productivity area in a similar manner.

Subsequent to computing the scores for the productivity areas, the AI personalization application 110 may remove certain elements from the personalized data based upon the aforementioned rankings. In an example where the personalized data for a productivity area references ten documents, the AI personalization application 110 may remove documents from the personalized data that have rankings below a threshold value (e.g., below a top five ranking); however, the score for the productivity area is still based upon the ten documents. The AI personalization application 110 may perform similar actions for the people and the derived information as well.

The AI personalization application 110 assigns rankings to the productivity areas based upon the scores. The AI personalization application 110 causes graphical data pertaining to at least a subset of the productivity areas to be presented on the display 140 based upon the rankings. According to embodiments, the AI personalization application 110 presents graphical data for productivity areas that are ranked above a threshold ranking (e.g., the top five ranked productivity areas).

The AI personalization application 110 may transmit the scores (described above) to the canvas application 134. The AI personalization application 110 may also transmit the personalized data to the canvas application 134, where the personalized data is for the one or more productivity areas of the user 116. For each productivity area, the personalized data may include an identifier for the productivity area, an identifier for the topics related to the productivity area, identifiers for acronyms and definitions of the acronyms related to the productivity area, identifiers for commitments of the user 116 (e.g., task the user 116 has agreed to complete), identifiers for people related to the productivity area, identifiers for meetings related to the productivity area, identifiers for emails related to the productivity area, and identifiers for documents related to the productivity area.

The canvas application 134 presents the GUI 142 on the display 140, where contents (e.g., graphical data) of the GUI 142 are based upon the scores and optionally, the personalized data. In an example, the GUI 142 may include a plurality of regions, where each region is assigned to a different productivity area identified vis-à-vis the clustering of the nodes of the user graph 114. A region assigned to a productivity area includes a score for the productivity area, where the score is indicative of an amount of effort exerted by the user 116 in the productivity area over a period of time. The region assigned to the productivity area may also include identifiers for people, identifiers for documents, and/or identifiers for derived information that are obtained based upon the walk of the user graph 114 described above. Via the different regions of the GUI 142, the user 116 is able to visualize productivity areas, easily access data associated therewith, and easily view an amount of effort the user 116 has exerted in the productivity areas within the period of time.

According to embodiments, the AI personalization application 110 compares each of the scores to a threshold value. When a score for a productivity area exceeds the threshold value, the AI personalization application 110 flags the productivity area and causes a visual indication to be displayed within the GUI 142, where the visual indication notifies the user 116 that the user 116 is exerting a relatively large amount of effort in the productivity area within the period of time.

The visual indication may also include a suggestion that the user focus his/her efforts elsewhere.

According to embodiments, the threshold value is based upon job responsibilities of the user 116 as determined via the user graph 114 and/or the tenancy graph 122 and/or the threshold value is identified via a machine learning model. According to embodiments, when the score for the productivity area exceeds the threshold value, the AI personalization application 110 identifies a second user that belongs to a tenancy of the user 116 based upon the user graph 114 and/or the tenancy graph 122. The AI personalization application 110 causes an identifier for the second user to be presented within the GUI 142 along with a suggestion that the user 116 delegate certain activities performed with respect to the productivity area to the second user.

According to embodiments, the AI personalization application 110 compares each of the scores to a threshold value (which is identified based upon job responsibilities of the user 116 as determined via the user graph 114 and/or the tenancy graph 122 and/or which is identified via a machine learning model). When a score for a productivity area falls below the threshold value, the AI personalization application 110 flags the productivity area and causes a visual indication to be displayed within the GUI 142, where the visual indication notifies the user 116 that the user 116 is exerting a relatively small amount of effort in the productivity area within the period of time, along with a suggestion that user exert more effort in the productivity area.

According to embodiments, the AI personalization application 110 generates suggestions for a productivity area based upon people identified as being relevant to the productivity area and the score for the productivity area. In an example, the AI personalization application 110 identifies job titles of people within a productivity area via the user graph 114 and/or the tenancy graph 122.

In another example, the AI personalization application 110 determines positions of the people and the user 116 within a hierarchy of an organization. When the score for the productivity area indicates that the user 116 has exerted a relatively low amount of effort in the productivity area within the period of time and where the user 116 is subordinate to some or all of the people in the productivity area, the AI personalization application 110 generates and displays a suggestion that the user 116 spend more time working in the productivity area.

As noted above, the scores computed by the AI personalization application 110 are based upon types of activities performed by the user 116 and a number of times each of the activities were performed within a period of time. As such, a score for a productivity area of the user 116 is composed of sub-scores for different types of activities, where a sub-score for an activity reflects a number of times the user 116 performed an activity in the productivity area within the period of time. In an example, activities for the productivity area performed by the user 116 include a first activity of a first type, a second activity of a second type, and a third activity of the first type, the AI personalization application 110 assigns a first weight to the first activity, a second weight to the second activity, and the first weight to the third activity. The AI personalization application 110 computes a first sub-score for the first type of activity and a second sub-score for the second type of activity, where the first sub-score includes two instances of the first weight and where the second sub-score includes one instance of the second weight. According to embodiments, the AI personalization application 110 compares a sub-score for a type of activity to a threshold value for the type of activity and presents a suggestion to the user 116 based upon the comparison. The threshold value may be learned via a machine learning model, specified by the user 116, or specified by a tenancy (e.g., an organization) to which the user 116 belongs. The threshold value may be identified based upon job responsibilities of the user 116 as determined via the user graph 114 and/or the tenancy graph 122. In a specific example, the AI personalization application 110 compares a sub-score for drafting emails (for a productivity area) to a threshold value for drafting emails. When the sub-score for drafting emails exceeds the threshold value, the AI personalization application 110 generates a suggestion that the user 116 spend less time drafting emails and causes the suggestion to be presented on the display 140 as part of the GUI 142. In another specific example, the AI personalization application 110 compares a sub-score for attending meetings (for the productivity area) to a threshold value for attending meetings. When the sub-score for attending meetings is less than the threshold value, AI personalization application 110 generates a suggestion that the user 116 spend more time attending meetings and causes the suggestion to be presented on the display 140 as part of the GUI 142.

According to embodiments, the AI personalization application 110 may utilize the above-described processes to compute scores for productivity areas periodically (e.g., once a week). The AI personalization application 110 may cause previously computed scores to be presented within the GUI 142 to enable the user 116 to visualize his/her efforts in different productivity areas over time.

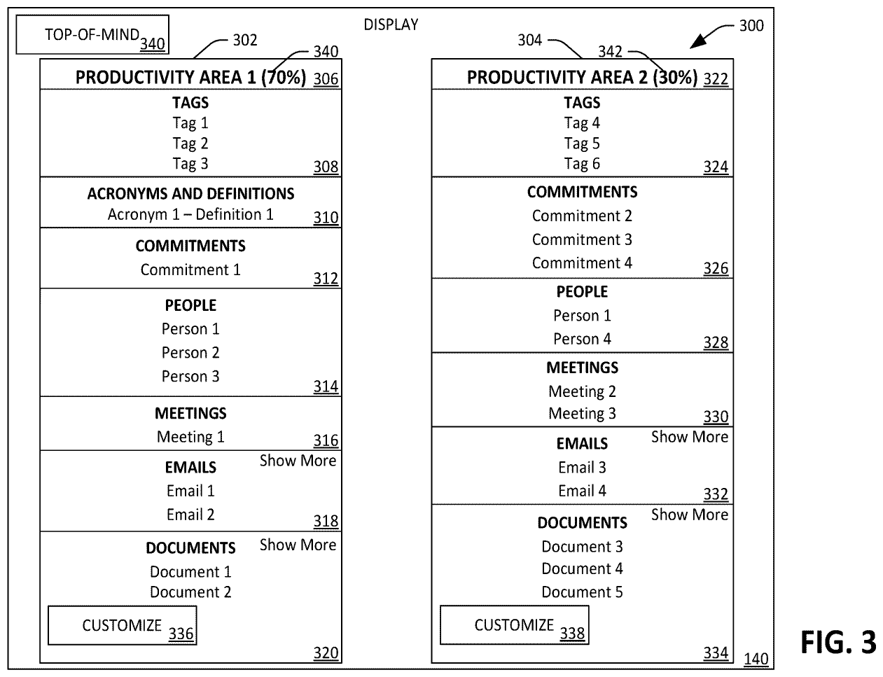

Turning now to FIG. 3, an example GUI 300 of the canvas application 134 is illustrated. The GUI 300 may be or include the GUI 142 or the GUI 142 may be or include the GUI 300. The GUI 300 includes a first region 302 corresponding to a first productivity area of the user 116 and a second region 304 corresponding to a second productivity area of the user 116, where the first productivity area and the second productivity area are identified by the AI personalization application 110 vis-à-vis clustering of nodes of the user graph 114. Although not depicted in FIG. 3, it is to be understood that the GUI 300 may include additional regions corresponding to additional productivity areas of the user 116 identified vis-à-vis clustering of nodes in the user graph 114 (described above).

The first region 302 corresponding to the first productivity area of the user 116 includes an identifier for the first productivity area 306. The first region 302 further includes tags 308, where each tag 308 is an identifier for a topic (represented by a topic node in the user graph 114) that was used to generate the first productivity area. The first region 302 includes acronyms and definitions 310 corresponding to the first productivity area, where the acronyms and definitions are based upon the derived information identified from the walk of the user graph 114. The first region 302 further includes identifiers for commitments 312 (e.g., tasks to be completed) of the user 116 with respect to the first productivity area. The first region 302 also includes identifiers for people 314 (e.g., contacts of the user 116) that are related to the first productivity area. The first region 302 additionally includes identifiers for meetings 316 that the user 116 has or will attend with respect to the first productivity area. An identifier for a meeting may include a title of the meeting and a date and time of the meeting. The first region 302 also includes identifiers for emails 318 that are related to the first productivity area. The first region 302 further includes identifiers for (non-message related) documents 320 (e.g., text documents, spreadsheets, etc.) related to the first productivity area. Orderings of the identifiers within the first region 302 may be based rankings of their corresponding people/documents/derived information.

The second region 304 corresponding to the second productivity area of the user 116 includes elements similar to those of the first region 302. For instance, the second region 304 includes tags 324 corresponding to the second productivity area, identifiers for commitments 326 of the user 116 corresponding to the second productivity area, identifiers for people 328 related to the second productivity area, identifiers for meetings 330 related to the second productivity area, identifiers for emails 332 related to the second productivity area, and identifiers for documents 334 related to the second productivity area. However, as the second productivity area is different than the first productivity area, certain elements of the second region 304 differ from the first region 302. In the example shown in FIG. 3, the second region 304 does not include acronyms and definitions.

The first region 302 of the GUI 300 may include a first customize button 336. When the GUI 300 receives a selection of the first customize button 336, the canvas application 134 may receive customizations as input from the user 116. Example customizations include changing orderings of the identifiers displayed within the first region 302 of the GUI 300, including more or less identifiers in each category of identifiers displayed within the first region 302 of the GUI 300, removing or adding categories of identifiers displayed within the first region 302 of the GUI 300, font type/font size/font color changes, and so forth. Likewise, the second region 304 may include a second customize button 338 that provides functionality similar to the functionality provided by the first customize button 336; however, any customizations performed via the second customize button 338 are particular to the second region 304 representing the second productivity area (and not the first region 302 representing the first productivity area). In this manner, the user 116 may individually customize different regions within the GUI 300 according to his/her preferences.

It is to be understood that the identifiers displayed within the first region 302 and the second region 304 of the GUI 300 are selectable. When the GUI 300 receives a selection of an identifier, the canvas application 134 performs an action with respect to the identifier. In an example, when the GUI 300 receives a selection of “Person 1” displayed in the identifiers for people 314, the canvas application 134 causes an email to be generated and displayed to the user 116, where the email message is auto-addressed to “Person 1”, includes an identifier for the first productivity area in a subject line of the email, and has an empty body that can be completed by the user 116. In another example, when the GUI 300 receives a selection of “Document 1” displayed in the identifiers for documents 320, the canvas application 134 causes “Document 1” to be opened in an application corresponding to a type of “Document 1”, where the application presents “Document 1” to the user 116.

According to embodiments, the first productivity area and the second productivity are ranked as described above. As such, the first region 302 corresponding to the first productivity area and the second region 304 corresponding to the second productivity area are positioned within the GUI 300 based upon their respective rankings.

The GUI 300 may also include a top-of-mind button 340. When the GUI 300 receives a selection of the top-of-mind button 340, the canvas application 134 removes regions of the GUI 300 corresponding to productivity areas that are not immediately relevant to the user 116. The AI personalization application 110 may determine immediate relevance of a productivity area based upon metadata for nodes traversed while performing the walk of the user graph 114. In an example, the user 116 has a task (e.g., a commitment) within the first productivity area that is to be completed within the next day, while the second productivity area has a meeting that is to occur in three weeks. Based upon such information, the canvas application 134 removes the second region 304 from the GUI 300.

According to embodiments, information presented within the canvas application GUI 142 may be supplemented with information obtained from a walk of the tenancy graph 122, where the walk of the tenancy graph 122 is based upon identifiers for people, identifiers for documents, and/or identifiers for derived information for a productivity area of the user 116 identified via clustering of the user graph 114.

The GUI 300 further includes a first score 340 for the first productivity area and a second score 342 for the second productivity area, where the AI personalization application 110 computes the first score 340 and the second score 342 in the manner described above. In the example depicted in FIG. 3, the user 116 has exerted 70% of his/her efforts in the first productivity area within the period of time and 30% of his/her efforts in the second productivity area within the period of time.

As noted above, the AI productivity application 110 may identify people (e.g., contacts of the user 116) that are relevant to a productivity area via performing the walk of the user graph 114. In an example, the AI productivity application 110 identifies people that are part of a team that works in the productivity area (as well as in other productivity areas). According to embodiments, the AI productivity application 110 (using the above-described processes) computes scores for each productivity area for each team member within the period of time based upon respective user graphs for each team member. In an example where a team includes a first team member, a second team member, and a third team member that each work in a first productivity area, a second productivity area, and a third productivity area (identified via clustering of nodes in user graphs for each of the team members), the AI personalization application 110 computes a first set of scores for the first team member, a second set of scores for the second team member, and a third set of scores for the third team member, where a set of scores for a team member includes a score for the first productivity area, a second score for the second productivity area, and a third score for the third productivity area. The AI personalization application 110 then computes an overall score for each productivity area based upon the scores for each productivity area for each team member, where an overall score for a productivity area is indicative of an amount of effort spent by members of the team in the productivity area within the period of time. Following the example given above, the AI personalization application 110 computes a first overall score for the first productivity area, a second overall score for the second productivity area, and a third overall score for the third productivity area.

According to embodiments, the AI personalization application 110 may compute overall sub-scores for an overall score for a productivity area, where an overall sub-score is indicative of an amount of effort spent by members of the team performing a type of activity (e.g., drafting emails, attending meetings, etc.) within the productivity area within the period of time. The AI personalization application 110 may generate suggestions for optimizing time management of the team based upon an overall sub-score for a productivity area in a manner similar to that described above and may present the suggestions on a display. For instance, the AI personalization application 110 generates suggestions by comparing an overall sub-score for a type of activity in a productivity area with a threshold value for the type of activity.

The AI personalization application 110 may cause the overall scores to be presented on the display 140. In an example, the overall scores are presented within the canvas application GUI 142.

According to embodiments, the AI personalization application 110 may present the overall scores on a display of a computing device operated by a leader of the team, whereupon the leader of the team may inspect the scores and make decisions as to how to better allocate resources. According to embodiments, the AI personalization application 110 may utilize AI algorithms and models to recommend suggested changes to the team leader or individual team members with respect to the different productivity areas.

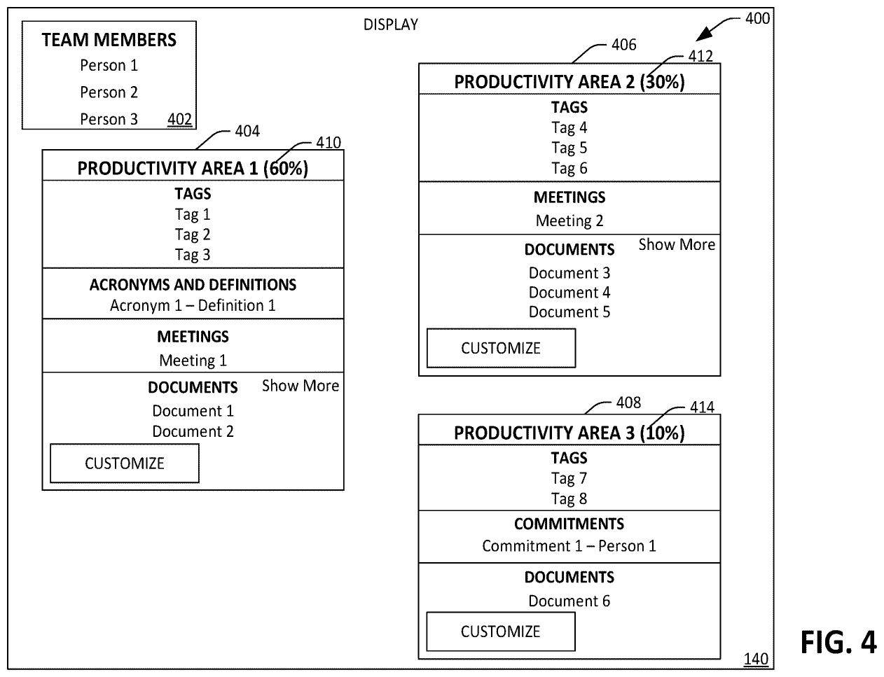

Turning now to FIG. 4, an example GUI 400 presented on the display 140 that facilitates time management of a team is depicted. The GUI 400 may be or include the canvas application GUI 142 or the canvas application GUI 142 may be or include the GUI 400. The GUI 400 is similar to the GUI 300 described above (e.g., the GUI 400 includes identifiers for the productivity areas, selectable identifiers for people/documents/derived information pertaining to the productivity areas, customize buttons, and so forth); however, unlike the GUI 300 which is generated with respect to the user 116, the GUI 400 is generated with respect to a team including a plurality of members (e.g., users). As such, the GUI 400 includes a team members section 402 that display identifiers for members of a team (e.g., a first person, a second person, and a third person) that work in different productivity areas (e.g., a first productivity area, a second productivity area, and a third productivity area). In the example depicted in FIG. 4, the GUI 400 includes a first region 404 assigned to the first productivity area, a second region 406 assigned to the second productivity area, and a third region 408 assigned to the third productivity area. The GUI 400 also includes a first overall score 410 for the first productivity area (e.g., 60%), a second overall score 412 for the second productivity area (e.g., 30%), and a third overall score 414 for the third productivity area (e.g., 10%), where an overall score for a productivity area is computed based upon respective types of activities and a number of times each of the activities were performed by the team members with respect to the productivity area within a period of time. Each of the first overall score 410, the second overall score 412, and the third overall score 414 may be normalized. The first overall score 410 is indicative of an amount of effort exerted by the team members in the first productivity area within the period of time, the second overall score 412 is indicative of an amount of effort exerted by the team members in the second productivity area within the period of time, and the third overall score 414 is indicative of an amount of effort exerted by the team members in the third productivity area within the period of time. The first region 404, the second region 406, and the third region 408 are customizable in a manner similar to that described above with respect to the GUI 300.

As the GUI 400 displays analytics at a team level (as opposed to a user level), user privacy is preserved. A leader of the team (e.g., a manager) may view the overall scores within the different regions of the GUI 400. Alternatively, as noted above, the AI personalization application 110 may generate suggestions as to how to optimize team productivity and present the suggestions to the leader. In an example, if an overall score for a productivity area (such as live site handling of a service) exceeds a threshold value (specified manually or learned via a machine learning model), the AI personalization application 110 can generate and display a suggestion that the team's priorities be altered.

Although the above-described processes have been described as being performed by computing system 102 and the computing device 124, other possibilities are contemplated. According to embodiments, the AI personalization application 110 executes on the computing device 124 and the user graph 114 is stored in local storage of the computing device 124. According to the embodiments, the computing device 124 computes the scores for the productivity areas and presents the scores on the display 140.

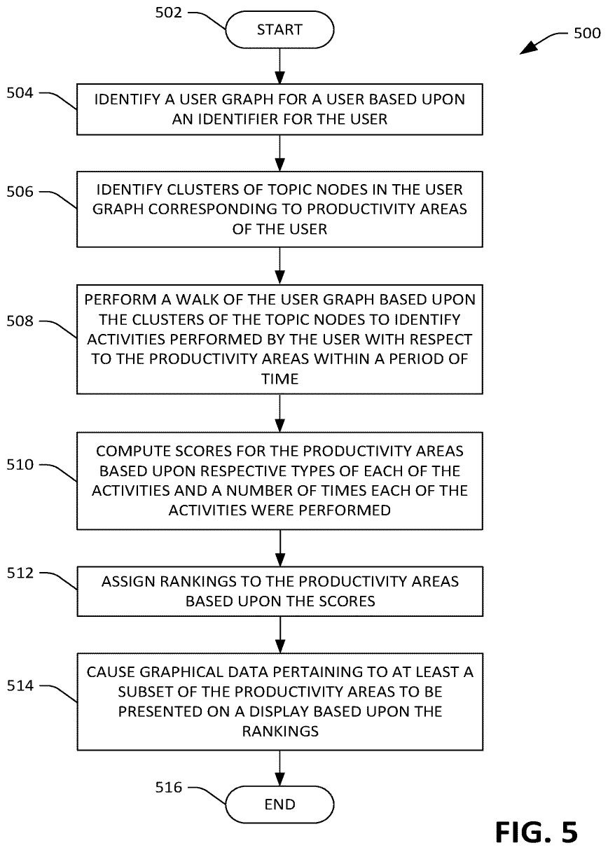

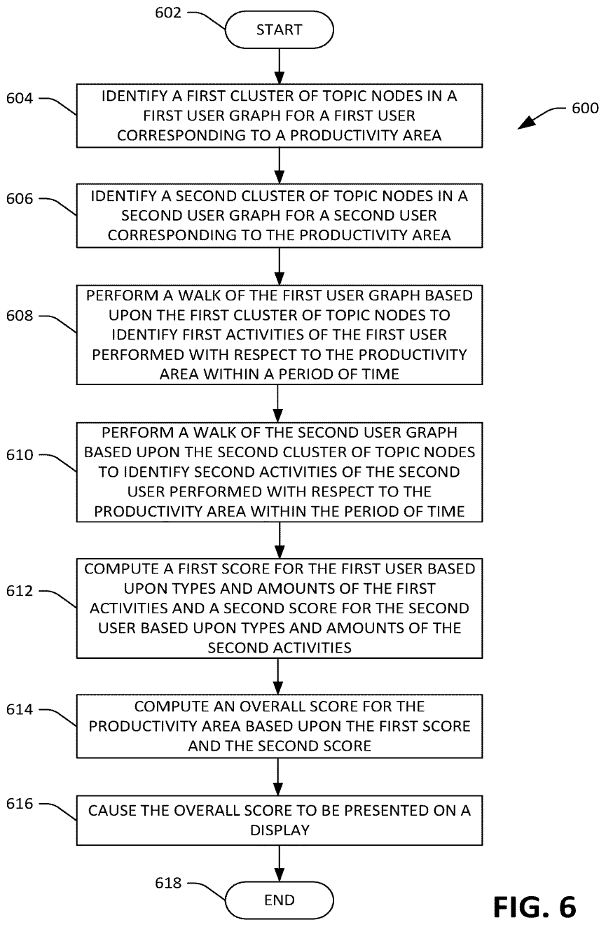

FIGS. 5 and 6 illustrate exemplary methodologies relating to facilitating time management via graph intelligence. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media.

The computer-executable instructions can include a routine, a sub-routine, programs, a thread of execution, and/or the like. Still further, results of acts of the methodologies can be stored in a computer-readable medium, displayed on a display device, and/or the like.

Referring now to FIG. 5, a methodology 500 performed by a computing system that facilitates time management via graph intelligence is illustrated. The methodology 500 begins at 502, and at 504, the computing system identifies a user graph for a user from amongst a plurality of user graphs for users based upon an identifier for the user. The user graph includes nodes and edges connecting the nodes. The nodes include topic nodes representing topics of the user and entity nodes, where the entity nodes represent documents associated with the user. At 506, the computing system identifies clusters of the topic nodes corresponding to productivity areas of the user. At 508, the computing system performs a walk of the user graph based upon the clusters of the topic nodes to identify activities performed by the user with respect to the productivity areas within a period of time. At 510, the computing system computes scores for the productivity areas based upon respective types of each of the activities and a number of times each of the activities were performed by the user within the time period. A score for a productivity area is based upon respective types of activities performed by the user with respect to the productivity area and a number of times each of the activities were performed by the user with respect to the productivity area within the period of time. The score is indicative of an amount of effort the user exerted in the productivity area within the period of time. At 512, the computing system assigns rankings to the productivity areas based upon the scores. At 514, the computing system causes graphical data pertaining to at least a subset of the productivity areas to be presented on a display based upon the rankings. The methodology 500 concludes at 516.

Turning now to FIG. 6, a methodology 600 performed by a computing system that facilitates time management of a team via graph intelligence is illustrated. The methodology 600 begins at 602, and at 604, the computing system identifies a first cluster of topic nodes in a first user graph for a first user, the first cluster of topic nodes corresponding to a productivity area. At 606, the computing system identifies a second cluster of topic nodes in a second user graph for a second user, the second cluster of topic nodes also corresponding to the productivity area. In an example, the first user and the second user belong to a tenancy, such as a team. At 608, the computing system performs a walk of the first user graph based upon the first cluster of topic nodes to identify first activities performed by the first user with respect to the productivity area within a period of time extending from a current time to a prior time, where the prior time occurs before the current time. At 610, the computing system performs a walk of the second user graph based upon the second cluster of topic nodes to identify second activities performed by the second user with respect to the productivity area within the period of time. At 612, the computing system computes a first score for the first user based upon types and amounts of the first activities and a second score for the second user based upon types and amounts of the second activities, where the first score is indicative of an amount of effort the first user exerted in the productivity area within the period of time and where the second score is indicative of an amount of effort the second user exerted in the productivity area within the period of time. At 614, the computing system computes an overall score for the productivity area based upon the first score and the second score, where the overall score is indicative of an amount of effort exerted by the team in the productivity area within the period of time. At 616, the computing system causes the overall score to be presented on a display. The methodology 600 concludes at 618.

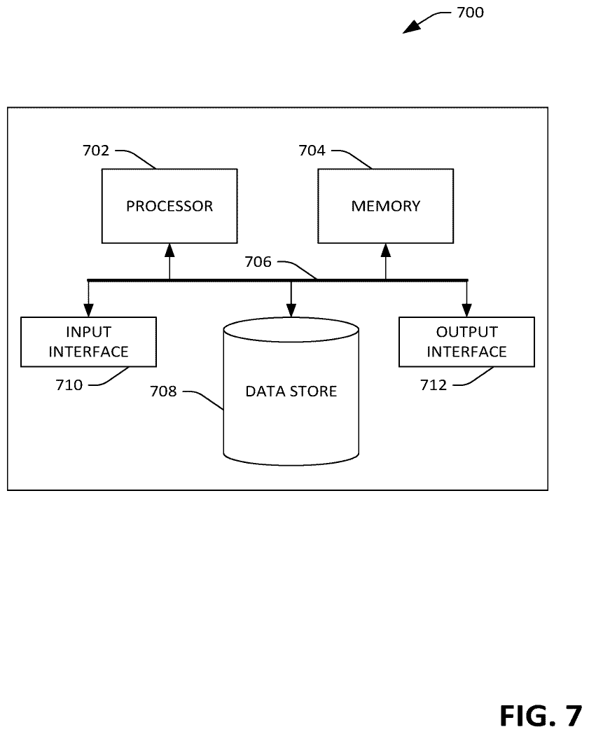

Referring now to FIG. 7, a high-level illustration of an exemplary computing device 700 that can be used in accordance with the systems and methodologies disclosed herein is illustrated. For instance, the computing device 700 may be used in a system that facilitates time management via graph intelligence. By way of another example, the computing device 700 can be used in a system that displays a GUI that facilitates time management via graph intelligence. The computing device 700 includes at least one processor 702 that executes instructions that are stored in a memory 704.

The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store user graphs, tenancy graphs, documents, derived information, etc.

The computing device 700 additionally includes a data store 708 that is accessible by the processor 702 by way of the system bus 706. The data store 708 may include executable instructions, user graphs, tenancy graphs, documents, derived information, etc. The computing device 700 also includes an input interface 710 that allows external devices to communicate with the computing device 700. For instance, the input interface 710 may be used to receive instructions from an external computer device, from a user, etc. The computing device 700 also includes an output interface 712 that interfaces the computing device 700 with one or more external devices. For example, the computing device 700 may display text, images, etc. by way of the output interface 712.

It is contemplated that the external devices that communicate with the computing device 700 via the input interface 710 and the output interface 712 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 700 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 700 may be a distributed system. Thus, for instance, several devices may be in communication by way of a network connection and may collectively perform tasks described as being performed by the computing device 700.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. Such computer-readable storage media can include random-access memory (RAM), read-only memory (ROM), electrically erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The present disclosure relates to facilitating time management of a user via graph intelligence according to at least the following examples:

(A1) In one aspect, some embodiments include a method (e.g., 500) executed by a processor (e.g., 104) of a computing system (e.g., 102). The method includes identifying (e.g., 504) a computer-implemented user graph (e.g., 114, 200) for a user (e.g., 116) from amongst a plurality of computer-implemented user graphs for users based upon an identifier for the user, where the user graph includes nodes and edges connecting the nodes. The nodes include topic nodes and entity nodes, where the entity nodes represent documents associated with the user. The method further includes identifying (e.g., 506) clusters (e.g., 202, 204) of the topic nodes corresponding to productivity areas of the user. The method additionally includes performing (e.g., 508) a walk of the user graph based upon the clusters of the topic nodes to identify activities performed by the user with respect to the productivity areas within a period of time. The method also includes computing (e.g., 510) scores for the productivity areas for the user, where a score for a productivity area is based upon respective types of activities performed by the user with respect to the productivity area and a number of times each of the activities were performed by the user with respect to the productivity area within the period of time. The method further includes assigning (512) rankings to the productivity areas based upon the scores. The method additionally includes causing (514) graphical data pertaining to at least a subset of the productivity areas to be presented on a display (e.g., 140) based upon the rankings.

(A2) In some embodiments of the method of A1, the graphical data is presented within a graphical user interface (GUI) (e.g., 142, 300) for a productivity application (e.g., 132).

(A3) In some embodiments of any of the methods of A1-A2, the period of time extends from a current time to a prior time.

(A4) In some embodiments of any of the methods of A1-A3, the activities performed by the user with respect to the productivity area include a first activity and a second activity, where the first activity has a first type and the second activity has a second type, where the first activity is assigned a first weight based upon the first type and the second activity is assigned a second weight based upon the second type, where the score is based upon the first weight and the second weight.

(A5) In some embodiments of any of the methods of A1-A4, the activities performed by the user with respect to the productivity area include one or more of drafting first emails, reading second emails, participating in real-time message exchanges, attending meetings, authoring first documents, or reading second documents.

(A6) In some embodiments of any of the methods of A1-A5, the graphical data includes a current score for the productivity area from the scores and a prior score for the productivity area, wherein the prior score was computed before the score, and further wherein the prior score corresponds to a second period of time that is different than the period of time.

(B1) In another aspect, some embodiments include a computing system (e.g., 102) that includes a processor (e.g., 104) and memory (e.g., 106). The memory stores instructions that, when executed by the processor, cause the processor to perform any of the methods described herein (e.g., any of A1-A6).

(C1) In yet another aspect, a non-transitory computer-readable storage medium includes instructions that, when executed by a processor (e.g., 104) of a computing system (e.g., 102), cause the processor to perform any of the methods described herein (e.g., any of A1-A6).

(D1) In another aspect, some embodiments include a method executed by a computing system (e.g., 102) that includes a processor (e.g., 104) and memory (e.g., 106). The method includes identifying a computer-implemented user graph (e.g., 114, 200) for a user (e.g., 116) from amongst a plurality of computer-implemented user graphs for users based upon an identifier for the user, where the user graph includes nodes and edges connecting the nodes. The nodes include topic nodes and entity nodes, where the entity nodes represent documents associated with the user. The method further includes identifying clusters (e.g., 202, 204) of the topic nodes corresponding to productivity areas of the user. The method additionally includes performing a walk of the user graph based upon the clusters of the topic nodes to identify activities performed by the user with respect to the productivity areas within a period of time. The method also includes computing scores for the productivity areas for the user, where a score for a productivity area is based upon respective types of activities performed by the user with respect to the productivity area and a number of times each of the activities were performed by the user with respect to the productivity area within the period of time. The method further includes assigning rankings to the productivity areas based upon the scores. The method additionally includes causing graphical data pertaining to at least a subset of the productivity areas to be presented on a display (e.g., 140) based upon the rankings.

(D2) In some embodiments of the method of D1, the method further includes determining whether the score for the productivity area exceeds a threshold value for the productivity area. The method additionally includes when the score exceeds a threshold value, identifying a second user that belongs to a tenancy of the user via the user graph or a computer-implemented tenancy graph (e.g., 122), where the graphical data includes an identifier for the second user and a suggestion that the user delegate certain activities performed with respect to the productivity area to the second user.

(D3) In some embodiments of any of the methods of D1-D2, the method further includes determining whether the score for the productivity area exceeds a threshold value for the productivity area. The method additionally includes when the score exceeds the threshold value, generating a suggestion that the user work in the productivity area for a lesser amount of time than an amount of time the user worked in the productivity area within the period of time, where the suggestion is presented within the graphical data.

(D4) In some embodiments of any of the methods of D1-D3, the scores are additionally computed based upon amounts of time spent by the user on each of the activities performed by the user with respect to the productivity areas, where the amounts of time are obtained from the user graph and weights assigned to each of the activities performed by the user with respect to the productivity areas, where the weights are based upon the respective types of the activities performed by the user with respect to the productivity areas.

(D5) In some embodiments of any of the methods of D1-D4, the activities performed by the user with respect to the productivity area include one or more of drafting first emails, reading second emails, participating in real-time message exchanges, attending meetings, authoring first documents, or reading second documents.

(D6) In some embodiments of any of the methods of D1-D5, performing the walk of the user graph includes selecting a topic node in a cluster of the topic nodes, traversing an edge connecting the topic node to an entity node within the user graph, determining a type of a document represented by the entity node based upon metadata for the entity node, determining a manner of access of the document based upon the metadata, and determining an activity performed by the user based upon the type of the document and the manner of access of the document.

(D7) In some embodiments of any of the methods of D1-D6, the productivity areas and the activities performed by the user with respect to the productivity areas within the period of time are identified via a plurality of graph clustering techniques.

(D8) In some embodiments of any of the methods of D1-D7, the graphical data comprises a first score (e.g., 340) for a first productivity area and a second score (e.g., 342) for a second productivity area.

(D9) In some embodiments of any of the methods of D1-D8, the method further includes identifying a second computer-implemented user graph for a second user from amongst the plurality of computer-implemented user graphs for the users based upon an identifier for the second user, where the second user graph includes second nodes and second edges connecting the second nodes. The second nodes include second topic nodes and second entity nodes, where the second entity nodes represent second documents associated with the second user. The method additionally includes identifying second clusters of the second topic nodes within the second user graph corresponding to second productivity areas of the second user, where the second productivity areas include the productivity area. The method also includes performing a second walk of the user graph based upon the second clusters of the topic nodes to identify second activities performed by the second user with respect to the second productivity areas within the period of time. The method further includes computing second scores for the second productivity areas for the second user, where a second score for the productivity area is based upon respective types of activities performed by the second user with respect to the productivity area and a number of times each of the activities were performed by the second user with respect to the productivity area within the period of time. The method additionally includes assigning second rankings to the second productivity areas based upon the second scores. The method also includes causing second graphical data pertaining to at least a subset of the second productivity areas to be presented on a second display based upon the second rankings.

(D10) In some embodiments of the method of D9, the user and the second user are members of a tenancy and the method further includes computing a third score based upon the score for the productivity area and the second score for the productivity area, where the third score is for the tenancy. The method additionally includes causing the third score to be presented on a third display to a third user, where the third user is a leader of the tenancy.

(D11) In some embodiments of any of the methods of D1-D10, the graphical data includes identifiers for first documents and identifiers for first people associated with a first productivity area and identifiers for second documents and identifiers for second people associated with a second productivity area.

(E1) In another aspect, a computing system (e.g., 102) includes a processor (e.g., 104) and memory (e.g., 106). The memory stores instructions that, when executed by the processor, cause the processor to perform any of the methods described herein (e.g., any of D1-D11).

(F1) In yet another aspect, a non-transitory computer-readable storage medium includes instructions that, when executed by a processor (e.g., 104) of a computing system (e.g., 102), cause the processor to perform any of the methods described herein (e.g., any of D1-D11).

(G1) In another aspect, some embodiments include a method executed by a computing system (e.g., 102) that includes a processor (e.g., 104). The method includes identifying a computer-implemented user graph (e.g., 114) for a user (e.g., 116) from amongst a plurality of computer-implemented user graphs for users based upon an identifier for the user. The user graph includes nodes and edges connecting the nodes. The nodes include topic nodes and entity nodes, where the entity nodes represent documents associated with the user. The method further includes identifying a first cluster (e.g., 202) of the topic nodes corresponding to a first productivity area of the user. The method additionally includes identifying a second cluster (e.g., 204) of the topic nodes corresponding to a second productivity area of the user. The method also includes performing a first walk of the user graph based upon the first cluster of the topic nodes to identify first activities performed by the user with respect to the first productivity area within a period of time. The method further includes performing a second walk of the user graph based upon the second cluster of the topic nodes to identify second activities performed by the user with respect to the second productivity area within the period of time. The method additionally includes computing a first score for the first productivity area for the user based upon respective types of each of the first activities and a number of times each of the first activities were performed within the period of time. The method also includes computing a second score for the second productivity area for the user based upon respective types of each of the second activities and a number of times each of the second activities were performed within the period of time. The method further includes assigning a first ranking to the first productivity area and a second ranking to the second productivity area based upon the first score and the second score. The method additionally includes causing graphical data pertaining to at least one of the first productivity area or the second productivity area to be presented on a display (e.g., 140) based upon the first ranking and the second ranking.

(G2) In some embodiments of the method of G1, the first score and the second score are normalized.

(G3) In some embodiments of any of the methods of G1-G2, the graphical data includes a first region (e.g., 302) assigned to the first productivity area and a second region (e.g., 304) assigned to the second productivity area, where the first region comprises an identifier for the first productivity area (e.g., 306) and the first score (e.g., 340), where the second region comprises an identifier for the second productivity area (e.g., 322) and the second score (e.g., 342).

(H1) In yet another aspect, a computing system (e.g., 102) includes a processor (e.g., 104) and memory (e.g., 106). The memory stores instructions that, when executed by the processor, cause the processor to perform any of the methods described herein (e.g., any of G1-G3).

(I1) In yet another aspect, a non-transitory computer-readable storage medium includes instructions that, when executed by a processor (e.g., 104) of a computing system (e.g., 102), cause the processor to perform any of the methods described herein (e.g., any of G1-G3).

As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1-15. (canceled)

16. A computing system, comprising:
a processor; and
memory storing instructions that, when executed by the processor, cause the processor to perform acts comprising:
identifying a computer-implemented user graph for a user from amongst a plurality of computer-implemented user graphs for users based upon an identifier for the user, wherein the user graph comprises nodes and edges connecting the nodes, wherein the nodes comprise:
topic nodes; and
entity nodes, wherein the entity nodes represent documents associated with the user;
identifying clusters of the topic nodes corresponding to productivity areas of the user;
performing a walk of the user graph based upon the clusters of the topic nodes to identify activities performed by the user with respect to the productivity areas within a period of time;
computing scores for the productivity areas for the user, wherein a score for a productivity area is based upon respective types of activities performed by the user with respect to the productivity area and a number of times each of the activities were performed by the user with respect to the productivity area within the period of time;
assigning rankings to the productivity areas based upon the scores; and
causing graphical data pertaining to at least a subset of the productivity areas to be presented on a display based upon the rankings.

17. The computing system of claim 16, the acts further comprising:
determining whether the score for the productivity area exceeds a threshold value for the productivity area; and
when the score exceeds a threshold value, identifying a second user that belongs to a tenancy of the user via the user graph or a computer-implemented tenancy graph, wherein the graphical data includes an identifier for the second user and a suggestion that the user delegate certain activities performed with respect to the productivity area to the second user.

18. The computing system of claim 16, the acts further comprising:
determining whether the score for the productivity area exceeds a threshold value for the productivity area; and
when the score exceeds the threshold value, generating a suggestion that the user work in the productivity area for a lesser amount of time than an amount of time the user worked in the productivity area within the period of time, wherein the suggestion is presented within the graphical data.

19. The computing system of claim 16, wherein the scores are additionally computed based upon:
amounts of time spent by the user on each of the activities performed by the user with respect to the productivity areas, wherein the amounts of time are obtained from the user graph; and
weights assigned to each of the activities performed by the user with respect to the productivity areas, wherein the weights are based upon the respective types of the activities performed by the user with respect to the productivity areas.

20. The computing system of claim 16, wherein the activities performed by the user with respect to the productivity area include one or more of:
drafting first emails;
reading second emails;
participating in real-time message exchanges;
attending meetings;
authoring first documents; or
reading second documents.

21. The computing system of claim 16, wherein performing the walk of the user graph comprises:
selecting a topic node in a cluster of the topic nodes;
traversing an edge connecting the topic node to an entity node within the user graph;
determining a type of a document represented by the entity node based upon metadata for the entity node;
determining a manner of access of the document based upon the metadata; and
determining an activity performed by the user based upon the type of the document and the manner of access of the document.

22. The computing system of claim 16, wherein the productivity areas and the activities performed by the user with respect to the productivity areas within the period of time are identified via a plurality of graph clustering techniques.

23. The computing system of claim 16, wherein the graphical data comprises a first score for a first productivity area and a second score for a second productivity area.

24. The computing system of claim 16, the acts further comprising:
identifying a second computer-implemented user graph for a second user from amongst the plurality of computer-implemented user graphs for the users based upon an identifier for the second user, wherein the second user graph comprises second nodes and second edges connecting the second nodes, wherein the second nodes comprise:
second topic nodes; and
second entity nodes, wherein the second entity nodes represent second documents associated with the second user;
identifying second clusters of the second topic nodes within the second user graph corresponding to second productivity areas of the second user, wherein the second productivity areas include the productivity area;
performing a second walk of the user graph based upon the second clusters of the topic nodes to identify second activities performed by the second user with respect to the second productivity areas within the period of time;
computing second scores for the second productivity areas for the second user, wherein a second score for the productivity area is based upon respective types of activities performed by the second user with respect to the productivity area and a number of times each of the activities were performed by the second user with respect to the productivity area within the period of time;
assigning second rankings to the second productivity areas based upon the second scores; and
causing second graphical data pertaining to at least a subset of the second productivity areas to be presented on a second display based upon the second rankings.

25. The computing system of claim 24, wherein the user and the second user are members of a tenancy, the acts further comprising:
computing a third score based upon the score for the productivity area and the second score for the productivity area, wherein the third score is for the tenancy; and
causing the third score to be presented on a third display to a third user, wherein the third user is a leader of the tenancy.

26. The computing system of claim 16, wherein the graphical data comprises identifiers for first documents and identifiers for first people associated with a first productivity area and identifiers for second documents and identifiers for second people associated with a second productivity area.

27. A method executed by a processor of a computing system, the method comprising:
identifying a computer-implemented user graph for a user from amongst a plurality of computer-implemented user graphs for users based upon an identifier for the user, wherein the user graph comprises nodes and edges connecting the nodes, wherein the nodes comprise:
topic nodes; and
entity nodes, wherein the entity nodes represent documents associated with the user;
identifying clusters of the topic nodes corresponding to productivity areas of the user;
performing a walk of the user graph based upon the clusters of the topic nodes to identify activities performed by the user with respect to the productivity areas within a period of time;
computing scores for the productivity areas for the user, wherein a score for a productivity area is based upon respective types of activities performed by the user with respect to the productivity area and a number of times each of the activities were performed by the user with respect to the productivity area within the period of time;
assigning rankings to the productivity areas based upon the scores; and
causing graphical data pertaining to at least a subset of the productivity areas to be presented on a display based upon the rankings.

28. The method of claim 27, wherein the graphical data is presented within a graphical user interface (GUI) for a productivity application.

29. The method of claim 27, wherein the period of time extends from a current time to a prior time.

30. The method of claim 27, wherein the activities performed by the user with respect to the productivity area comprise a first activity and a second activity, wherein the first activity has a first type and the second activity has a second type, wherein the first activity is assigned a first weight based upon the first type and the second activity is assigned a second weight based upon the second type, wherein the score is based upon the first weight and the second weight.

31. The method of claim 27, wherein the activities performed by the user with respect to the productivity area include one or more of:
drafting first emails;
reading second emails;
participating in real-time message exchanges;
attending meetings;
authoring first documents; or
reading second documents.

32. The method of claim 27, wherein the graphical data includes a current score for the productivity area from the scores and a prior score for the productivity area, wherein the prior score was computed before the score, and further wherein the prior score corresponds to a second period of time that is different than the period of time.

33. A non-transitory computer-readable storage medium comprising instructions that, when executed by a processor of a computing system, cause the processor to perform acts comprising:
identifying a computer-implemented user graph for a user from amongst a plurality of computer-implemented user graphs for users based upon an identifier for the user, wherein the user graph comprises nodes and edges connecting the nodes, wherein the nodes comprise:
topic nodes; and
entity nodes, wherein the entity nodes represent documents associated with the user;
identifying a first cluster of the topic nodes corresponding to a first productivity area of the user;
identifying a second cluster of the topic nodes corresponding to a second productivity area of the user;
performing a first walk of the user graph based upon the first cluster of the topic nodes to identify first activities performed by the user with respect to the first productivity area within a period of time;
performing a second walk of the user graph based upon the second cluster of the topic nodes to identify second activities performed by the user with respect to the second productivity area within the period of time;
computing a first score for the first productivity area for the user based upon respective types of each of the first activities and a number of times each of the first activities were performed within the period of time;
computing a second score for the second productivity area for the user based upon respective types of each of the second activities and a number of times each of the second activities were performed within the period of time;
assigning a first ranking to the first productivity area and a second ranking to the second productivity area based upon the first score and the second score; and
causing graphical data pertaining to at least one of the first productivity area or the second productivity area to be presented on a display based upon the first ranking and the second ranking.

34. The non-transitory computer-readable storage medium of claim 33, wherein the first score and the second score are normalized.

35. The non-transitory computer-readable storage medium of claim 33, wherein the graphical data comprises a first region assigned to the first productivity area and a second region assigned to the second productivity area, wherein the first region comprises an identifier for the first productivity area and the first score, wherein the second region comprises an identifier for the second productivity area and the second score.
